(19) United States
(12) Patent Application Publication
(10) Pub. No.: US 2024/0015176 A1
(43) Pub. Date: Jan. 11, 2024

(54) Domain Age-Based Security System

(71) Applicant: Bank of America Corporation, Charlotte, NC (US)

(72) Inventors: Jennie Egbert, Parker, CO (US); Jeffrey Texada, Carrollton, TX (US)

(21) Appl. No.: 17/859,690

(22) Filed: Jul. 7, 2022

(51) Int. Cl. H04L 9/40

(52) U.S. Cl. CPC H04L 63/1441; H04L 63/1416

(57) ABSTRACT

The email security computing platform analyzes pattern associated with criminal and/or malicious activities directed towards an enterprise computing system. Domain age is determined for one or more domains associated with inbound and outbound emails. When certain conditions are met or patterns are recognized, additional activities are triggered to predict a likelihood that malicious activity may occur. The email security computing platform may predict a likelihood (e.g., a weighting factor, percentage, and the like) of the possibility that an email or message chain is linked to a certain type of malicious activity. If these predictions meet certain threshold conditions, an alert or other notification may be generated and sent to an appropriate computer system to trigger one or more security procedures.

### BACKGROUND

Many organizations rely on email as an important communication tool. Threat actors continually use new methods when attempting to leverage email communication to when targeting an enterprise organization for malicious activity. For example, a growing concern for such organizations is the practice of “phishing,” which involves tricking a user into visiting a fraudulent website that appears to be a legitimate website or giving the appearance that the sender is associated with a legitimate business. This user may leverage further email communications to solicit access to a business organization's private information, such as financial information and/or monetary accounts. Additionally, the threat actor may then continue soliciting personal or sensitive information from the user and/or organization. For example, the user may be fooled into granting access to business accounts and/or allowing the threat actor to send and/or receive wire transfers. Additionally, the threat actor may solicit personal information from users that might then be used by the operators of the fraudulent website or others to steal the user's identity and/or make purchases under the user's name and account. Often, these fraudulent attempts may be accomplished through the use of email. In many instances, as phishing emails become more complex and look ever more legitimate, it may be harder for recipients to identify authentic emails from fraudulent ones. While assessing an age of a domain associated with the sender is one possible way of detecting potential threat actors, relying upon domain age alone can result in numerous false positives

### SUMMARY

Aspects of the disclosure provide effective, efficient, scalable, and convenient technical solutions that address and overcome the technical problems associated with domain age-based analysis of email communications and associated threats to computing system security. Methodologies that utilize domain age for triggering analysis of email communications for threat indicators may involve analyzing incoming and outgoing emails. For example, messages received from and sent to recently registered domains may be analyzed. In some cases, analysis may include processing of information and/or application of filters. In some cases, domain age analysis may be processed in a two-part format, such that domain age can be used as a trigger to initiate further analysis and pattern recognition from associated email information and/or metadata.

A domain age-based analysis system may process targeted queries that look for recently registered domains, such as domains registered within 1 day, 2 days, 5 days, 10 days, 20 days and the like. The age of the domains, associated with one or more of a sender field, a recipient field, a carbon copy (CC) field, may be analyzed to identify an address pattern associated with one or more attempts to solicit malicious activity. For example, identification of a domain having an age that meet a threshold condition, e.g., 1 day, 2 days, 10 days, and/or the like, may trigger additional domain pattern recognition activities, such as via a trained AI model. For example, the domain and/or other aspects of the email addresses associated with the message may be analyzed via a trained AI model to identify a pattern in name use, modifications of an email address (e.g., adding one or more characters, removing at least one character, adding a numeral or numerals, and the like). In an illustrative example, the AI model may be trained based on identified domain naming conventions that may be common to a particular threat actor or group of threat actors. In some cases, email information may be correlated based on a user domain, subject information, an external sender, a target industry, a particular customer, and the like.

In some cases, an alert may trigger an alert at an information security computing system of the enterprise organization, where additional review procedures may be performed on the suspect message, or messages related to a triggering message. In some cases, message logs may be analyzed to identify whether the suspect activity is newly started, or is an extension of earlier activities. For example, a suspect domain may be added to an email (e.g., in the CC field) after initial contact had been made and a response had been sent. In some cases, additional analysis and/or monitoring activities may be automatically triggered if an employee of the enterprise organization replies or had replied to a suspect email. For example, if a suspect email triggers analysis, and an employee response also is identified, an alert system may initiate a quarantine and/or monitoring process to monitor and/or quarantine activities for individuals associated with the triggering email. In some cases, a triggering email may initiate other analysis or import of additional information, such as from open source intelligence systems or internal business unit computing systems, to identify customer/client relationships between one or more individuals identified in the email and/or relationships between identified domains. In some cases, a domain of a link listed in the body of the email may also be used to trigger analysis.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B shows an illustrative computing environment for domain age-based monitoring of email communications according to aspects of this disclosure; and

FIGS. 2A and 2B shows an illustrative method for domain age-based monitoring of email communications according to aspects of this disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As mentioned, assessment of a domain age associated with an incoming email may be used for detecting potential threat actors. Relying upon domain age alone has proved problematic and can result in false positives. For example, certain businesses organizations (e.g., financial institutions, research institutions, and the like) may frequently do business with recently created businesses or business units, so that these business organizations may commonly receive emails from domains registered for as little as a single day. In an illustrative example, a domain age-based security system may perform domain analysis of incoming (and outgoing) emails from/to senders requesting a certain action be performed (e.g., a funds transfer request), or authorizing certain individuals to perform specific business functions (e.g., access financial accounts, authorize wire transfers, and the like). The domain age-based security system determines whether the email communications represent a security threat based on, for example, (1) an age of email domains; (2) whether there are multiple email domains associated with communications associated with the user; (3) any recent updates on the user's account (e.g., email, address, adding a signor to the account, etc.); and (4) keyword analysis of known words or phrases.

A process for domain age-based analysis of malicious activities and/or from sources similar to existing domains may include one or more of receiving or sending messages to a source external to the business organization; performance of keyword pattern analysis from subject lines of emails to correlate crossovers between different domains; correlating subject lines to identify commonalities for actions and/or updates to existing customer communications, such performance of account/admin level changes to perform certain actions (e.g., wire requests, funds transfer requests, and the like) and/or other updates (e.g., add new signer, and the like) to bubble up potential emails of interest; identifying a threat signature using an artificial intelligence/machine learning (AI/ML) keyword pattern model and a domain pattern model, analyzing bi-directional traffic patterns for both internal and external communications; matching patterns across multiple emails to isolate common indicators including in an IP address, a host name, a subject line, message content, and the like.

For example, an illustrative domain-age based security system to perform domain analysis of incoming (and outgoing) emails may be focus on certain requests to be performed (e.g., a funds transfer request, adding a new signor, and the like). The domain age-based security system identifies security threats based on (1) an age of email domains associated with different fields in the email communications; (2) whether there are multiple email domains being utilized by aa sender of the email communications; whether any recent updates have been made to the user's account (e.g., email, address, adding a signor to the account, etc.); and (4) analysis for use of certain key words or phrases.

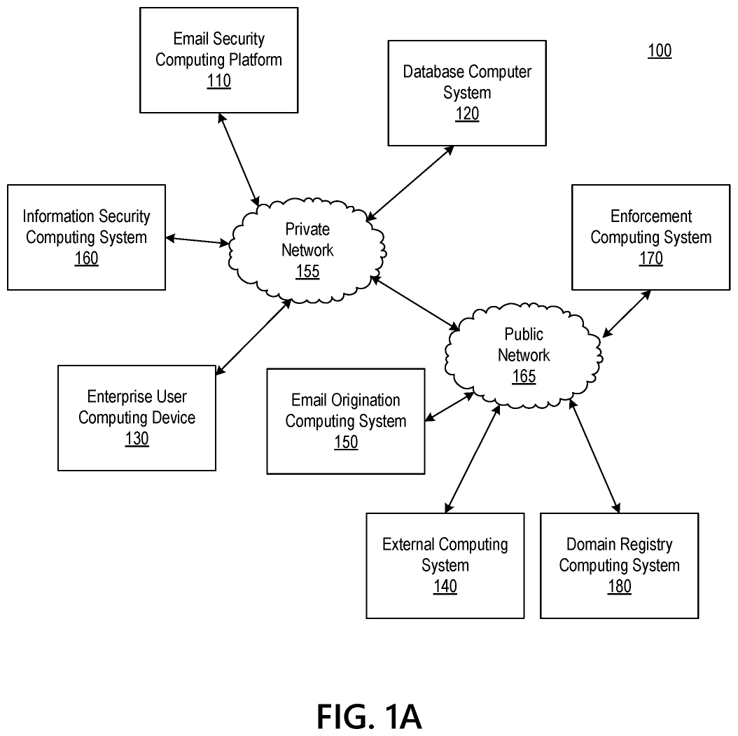

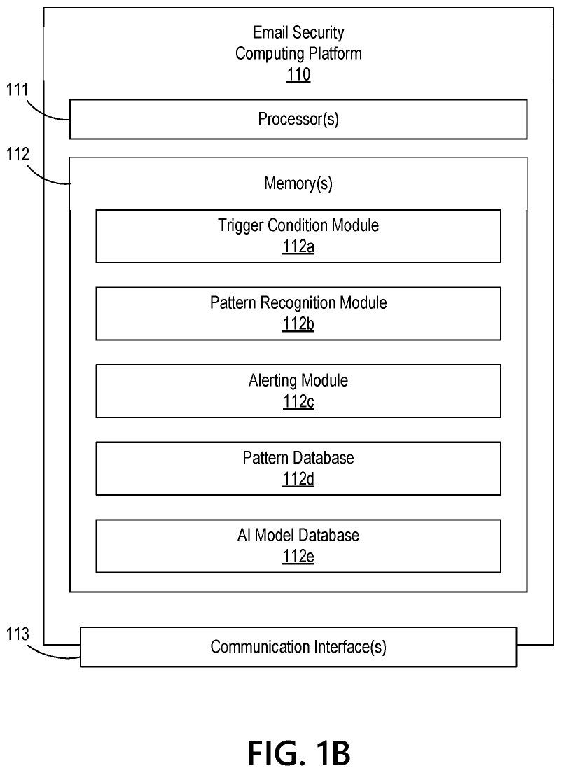

FIGS. 1A and 1B show an illustrative computing environment for domain age-based email security according to one or more aspects of this disclosure. Referring to FIG. 1A, a computing environment 100 may include one or more computing devices and/or other computing systems. For example, the computing environment 100 may include an email security computing platform 110, a database computer system 120, an enterprise user computing device 130, an external computing system 140, an email origination computing system 150, an information security computing system 160, an enforcement agency computing system 170, and a domain registry computing system 180. Although one enterprise user computing device 130 is shown for illustrative purposes, any number of enterprise user computing devices may be used without departing from the disclosure. In addition, although one external computing system 140 an done email origination computing system 150 are shown for illustrative purposes, any number of external computing devices or email origination computing systems may be used without departing from the disclosure.

As illustrated in greater detail below, the email security computing platform 110 may include one or more computing devices configured to perform one or more of the functions described herein. For example, email security computing platform 110 may include one or more computers (e.g., laptop computers, desktop computers, servers, server blades, or the like).

The database computer system 120 may include different information storage entities storing electronic messages and/or information associated with the electronic messages. In some examples, the database computer system 120 may store a collection of emails that have been previously sent (e.g., over a period of time). In some examples, the database computer system 120 may store electronic message information associating one or more portions of content of an electronic message with one or more message-specific identifiers embedded into the electronic message.

The enterprise user computing device 130 may include one or more computing devices and/or other computer components (e.g., processors, memories, communication interfaces). For instance, enterprise user computing device 130 may be a server, desktop computer, laptop computer, tablet, mobile device, or the like, and may be associated with an enterprise organization operating the email security computing platform 110. The external computing system 140 may include one or more computing devices and/or other computer components (e.g., processors, memories, communication interfaces). For instance, external computing system 140 may be a server, desktop computer, laptop computer, tablet, mobile device, or the like, and may be used by a customer of an organization, such as a customer of a financial institution or a threat actor impersonating a customer of the financial institution. The email origination computing system 150 may include one or more computing devices and/or other computer components (e.g., processors, memories, communication interfaces). For instance, email origination computing system 150 may be a server, desktop computer, laptop computer, tablet, mobile device, or the like, and may be used by a customer of an organization, such as a customer of a financial institution or a threat actor impersonating a customer of the financial institution.

The computing environment 100 also may include one or more networks, which may interconnect one or more of the email security computing platform 110, the database computer system 120, the enterprise user computing device 130, the external computing system 140, the email origination computing system 150, the information security computing system 160, the enforcement agency computing system 170, and the domain registry computing system 180. For example, the computing environment 100 may include a private network 155 and a public network 165. The private network 155 and/or the public network 165 may include one or more sub-networks (e.g., local area networks (LANs), wide area networks (WANs), or the like).

The private network 155 may be associated with a particular organization (e.g., a corporation, financial institution, educational institution, governmental institution, or the like) and may interconnect one or more computing devices associated with the organization. For example, the email verification computing platform 110, the database computer system 120, the enterprise user computing device 130, and the information security computing system 160 may be associated with an organization (e.g., a financial institution or the like), and the private network 155 may be associated with and/or operated by the organization, and may include one or more networks (e.g., LANs, WANs, virtual private networks (VPNs), or the like) that interconnect the email security computing platform 110, database computer system 120, enterprise user computing device 130, the information security computing system 160 and one or more other computing devices and/or computer systems that are used by, operated by, and/or otherwise associated with the organization.

The public network 160 may connect the private network 155 and/or one or more connected computing devices (e.g., the email security computing platform 110, database computer system 120, enterprise user computing device 130, the information security computing system 160) with one or more networks and/or computing devices that are not associated with the organization. For example, an email origination computing system 150 might not be associated with an organization that operates the private network 155, and the public network 165 may include one or more networks (e.g., the Internet) that connect the email origination computing system 150 to the private network 155 and/or one or more connected computing devices connected (e.g., the email security computing platform 110, database computer system 120, enterprise user computing device 130, the information security computing system 160).

In one or more arrangements, the email security computing platform 110, the database computer system 120, the enterprise user computing device 130, the external computing system 140, the email origination computing system 150, the information security computing system 160, the enforcement agency computing system 170, and the domain registry computing system 180 may be any type of computing device capable of receiving a user interface, receiving input via the user interface, and communicating the received input to one or more other computing devices. For example, the email security computing platform 110, the database computer system 120, the enterprise user computing device 130, the external computing system 140, the email origination computing system 150, the information security computing system 160, the enforcement agency computing system 170, and the domain registry computing system 180, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions.

Referring to FIG. 1B, email security computing platform 110 may include one or more processor(s) 111, memory(s) 112, and communication interface(s) 113. A data bus may interconnect the processor 111, the memory 112, and the communication interface 113. The communication interface 113 may be a network interface configured to support communication between email security computing platform 110 and one or more networks (e.g., the private network 155, the public network 165, or the like). The memory 112 may include one or more program modules storing instructions that when executed by the processor 111 cause the email security computing platform 110 to perform one or more functions as described and/or one or more databases and/or other libraries that may store and/or otherwise maintain information which may be used by such program modules and/or the processor 111.

In some instances, the one or more program modules and/or databases may be stored by and/or maintained in different memory units of the email security computing platform 110 and/or by different computing devices that may form and/or otherwise make up the email security computing platform 110. For example, the memory 112 may have, store, and/or include a trigger condition module 112a, a pattern recognition module 112b, an alerting module 112c, a pattern database 112d, an AI model database 112e, and/or the like. The trigger condition module 112a may have instructions that direct and/or cause email security computing platform 110 to, for instance, analyze the age of one or more domains associated with an email and determine how to further analyze the email communication and/or series of email communications, as discussed in greater detail below. The pattern recognition module 112b may have instructions that direct and/or cause email security computing platform 110 to, for instance, analyze information or metadata associated with the email for indications of patterns representative of malicious or felonious activities, as discussed in greater detail below. The alerting module 112c may have instructions that direct and/or cause email security computing platform 110 to, for instance, escalate a monitoring or enforcement activity based on threats identified by the trigger condition module 112a and the pattern recognition module 112b, including quarantining email communications or communication streams, generating alerts, generating a communication to initiate an enforcement activity, as discussed in greater detail below. The pattern database 112d may store information used by the trigger condition module 112a, the pattern recognition module 112b, and/or email security computing platform 110 in analyzing email communications to identify threats and/or malicious activity, as discussed in greater detail below. The AI model database 112e may store information used by the trigger condition module 112a, the pattern recognition module 112b, and/or email security computing platform 110, including trained models, untrained models, training data sets, to identify domain-age based trigger conditions of email sent and/or received by the enterprise organization's email system and/or to perform other functions, as discussed in greater detail below.

Domain age may be extremely relevant to successfully identifying security threats, malware threats, fraud threats, and/or other malicious or felonious activities. While domain age may be used to filter incoming and/or outgoing emails, such as by blocking network traffic or communications traffic to and/or from such domains, some organizations conduct business with known and legitimate clients that may send valid emails from new domains, even those that are 1 day old. As such, preventative measures, such as blocking, won't work. Instead, domain age may be used as an indicator, e.g., a trigger, that may be used to flag suspect emails for additional analysis.

In some cases, domain age information may be gathered from one or more domain registration authorities (e.g., domain registry computing system 180). In some cases, the domain information may be gathered based on analysis of email communication logs, or other data stores storing emails or email header information. In some cases, domain information may be gathered in real-time, in near real-time, or at a duration after receipt of the email by the enterprise organization's email system.

The email security platform 110 may analyze information associated with one or more emails, once triggered, to recognize threat actors or identify threats to security of the enterprise computing system and/or to protected information stored on or accessible via the enterprise computing system.

The email security platform 110 may use domain age as a starting point for analysis, e.g., to trigger data enrichment activities and subsequent data analysis, where the email security platform 110 may train the AI/ML models to continually learn based on that analysis.

In some cases, an email may be received with a domain age less than a threshold condition, where the associated entities are business entities (e.g., a newly incorporated business) with a newly registered domain. Such emails may be identified and released, such as by the pattern recognition module 112b.

In some cases, the pattern recognition module 112b may analyze the domain name and/or associated business names to identify whether the domain or the associated business, have similar names to existing and valid clients and/or vendors. In some cases, an additional email address may be added to a “to” field or a “CC” field of the email. Here, the pattern recognition module 112b may identify that a client has a name similar to the domain, with a long existing domain (e.g., 10 years), however an additional email has a similar domain (e.g., domain1.org and domain_1.com). Additional information included in the body of the email may include a request to add a newly permissioned individual or email address, to perform actions, such as to add an individual with signatory permissions and/or permissions to facilitate a wire transfer, and the like. Over time, the AI/ML model processed by the pattern recognition module 112b may be trained to identify one or more patterns over time. In some case, the AI/ML model, as it is trained, may identify evolution of patterns over time. As such, the email security computing platform 110 may be a behavioral and learning mechanism capable of observing, monitoring, and tracking trends of email-based threats to an enterprise computing system.

For example, the email security computing platform 110 may proactively identify potential security threats and identify when a threat may be occurring. Once identified, the email security computing platform 110 may predict whether an email or series of emails may lead to a security threat to the enterprise computing system. For example, an email-initiated security threat may include a threat actor requesting access to a secure computing system (e.g., an equities research portal), where the email security platform 110, via the trigger condition module 112a and the pattern recognition module 112b, may predict a next step of the threat actor. For example, the email security computing platform 110 go next and predict how threat actor's methods may likely evolve over time. In some cases, the pattern recognition module 112b, for example, may analyze whether a same word use, phrasing, spelling errors, past successful attempts cause the threat actor's methods to evolve over time. In some cases, the pattern recognition module 112b may identify similar approaches, where a first threat actor doing may perform a certain action (e.g., request access to equity research portal) and assign a probability to whether different threat actors may operate similarly. For example, the pattern recognition module may assign a predictive weight to a determination and, based on an overall predictive weight, may trigger an alert generation. In some cases, the pattern recognition module 112b may identify whether a threat actor using a particular domain or domains may target a first business unit via certain targeted emails, and may predict a next targeted individual or computing system based on past patterns.

In some cases, a threat actor may initially target specific industries (e.g., healthcare, investment advisors, and the like), specific roles within a business (e.g., a controller, a financial analyst, a payroll administrator, and the like. Over time, the pattern recognition module 112b may train the AI/ML model based on these activities to identify deviations from the expected behavior, identify new behavior, and continually train the AI/ML model based on this behavior. For example, the threat actor or actors may use a new domain, may change targeted individuals or roles, may first target a particular geographic region and adjust the attacks to target a different geographic region (e.g., New York then Colorado), or the like. Over time, the email security computing platform 110 may train the triggering AI/ML model used by the trigger condition module 112a and/or the AI/ML pattern recognition model used by the pattern recognition module 112b to identify nuanced patterns, where the threat activity may not be directly apparent until the activities are analyzed deeply over time.

The email security computing platform may pull data points automatically from different sources, where domain age is used as a trigger to initiate monitoring and/or deeper analysis of suspect activities. In some cases, all emails received and/or sent by the enterprise computing system may be monitored. In some cases, email to be routed to specific people and/or business units may be monitored. The email security computing platform 110 may identify the domain age for inbound emails and trigger additional analysis based on meeting a threshold. In some cases, over time, the triggering model may be trained to identify a recipient that may likely be targeted, where the model may have different trigger conditions for emails directed to that person. For example, if an email is directed to that individual, and is associated with a domain with an age less than x days old, additional analysis may be triggered. If that individual responds to that email, and where an associated domain has an age less than y days old (where y>x), additional analysis may be triggered. As can be seen, different domain ages may be used to trigger different analysis. In some cases, a threat escalation may occur when employees of the enterprise organization communicate or reply to the suspect emails. The email security computing platform 110 may predict, based on triggering pattern analysis and threat pattern analysis, a domain or strategy that may be most likely result in generating a response email from an employee. In some case, the email security computing platform 110 may identify outbound threats as well as inbound threats. For example, a leak or inside actor may generate an email to be sent to a newly registered domain, or may include a newly registered domain in the “to” field or “cc” fields in the email. The trigger condition module 112a may be configured to trigger additional analysis based on different threshold conditions, for one or more of an inbound threat or an inside threat.

The email security computing platform 110 expands on email log analysis and/or real-time email monitoring by leveraging the age of associated domains. The email security computing platform identifies a trigger conditions based on domain age and other domain information, and triggers additional analysis when identified. Patterns are identified based on message information and/or metadata, such as keywords, IP addresses, host names, word use and phrasing. Over time, internal models may be trained to evolve the pattern recognition as they evolve.

Queries may be performed against incoming messages and/or archived messages. In some cases, different patterns may be recognized. A first level pattern may be based on domain age and may be used to trigger additional pattern analysis. The patterns may be identified based on key words, subject line information, common phrasing, common misspellings or insertion of extra characters, and the like.

The email security computing platform 110 may identify traditional information security threats, such as spam, phishing attempts, and malware attacks. Additionally, the email security computing platform 110 may identify other malicious and/or criminal activities not normally identified through information security methods. In some cases, the email security computing platform may predict a likelihood (e.g., a weighting factor, percentage, and the like) of the possibility that an email or message chain is linked to a certain type of malicious or criminal activity. If these predictions meet certain threshold conditions, an alert or other notification may be generated and sent to an appropriate computer system to trigger one or more security procedures, such as locking a building, blocking access to account information, triggering a law enforcement activity and/or the like.

For example, certain threats may be directed differently within an enterprise organization, where malware threats may be associated with a malware threat remediation computing system, while fraud activities may be addressed by a different computing system. Additionally, once identified, certain threats and/or potential malicious activities may be modeled and trained on anonymized data sets, where such information may be used to train outside computing systems to reduce a possibility of a threat across an industry.

In an illustrative example, a threat actor may send an email to the enterprise computing systems, where the email is alleged to from a customer to introduce an individual (FirstName LastName) who will fill a specified role for that customer, such as a CPA or controller. The email may then purport to authorize that person to be added to all accounts and/or to ask for access to initiate and/or receive wire transfers on behalf of the customer. The domains may be extracted from the email, or the email log. In some cases, on an initial email a new domain may be identified. In other cases, known domains may be associated with all email addresses on the initial email, but new domains may be added to subsequent messages. Additionally, doppelganger addresses may be used, where a known domain (e.g., knowndomain.nnn) may be substituted with another similar domain that may be misspelled or otherwise altered (e.g., knowndomaln.nnn). Over time, the threat actor may evolve the attempts, where a same outside firm name may be used, but an associated name may change (e.g., from FirstName LastName to NewName LastName), or the title or associated company may change (e.g., from an accountant to a controller or office manager), where the patterns may shift over time. In some cases, patterns may be identified where a same outside email address on a public email domain, rather than an email associated with a company domain.

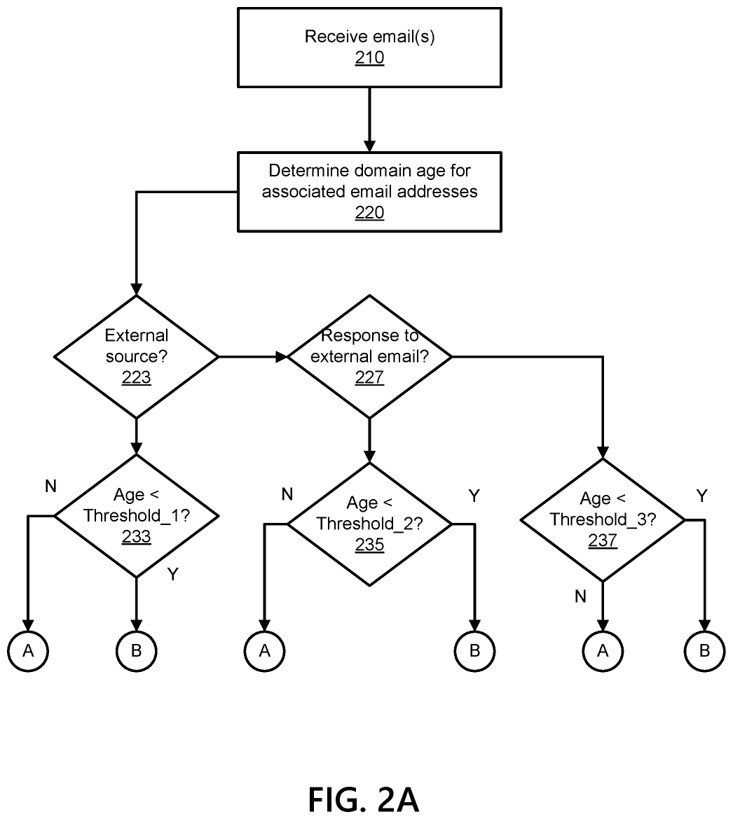

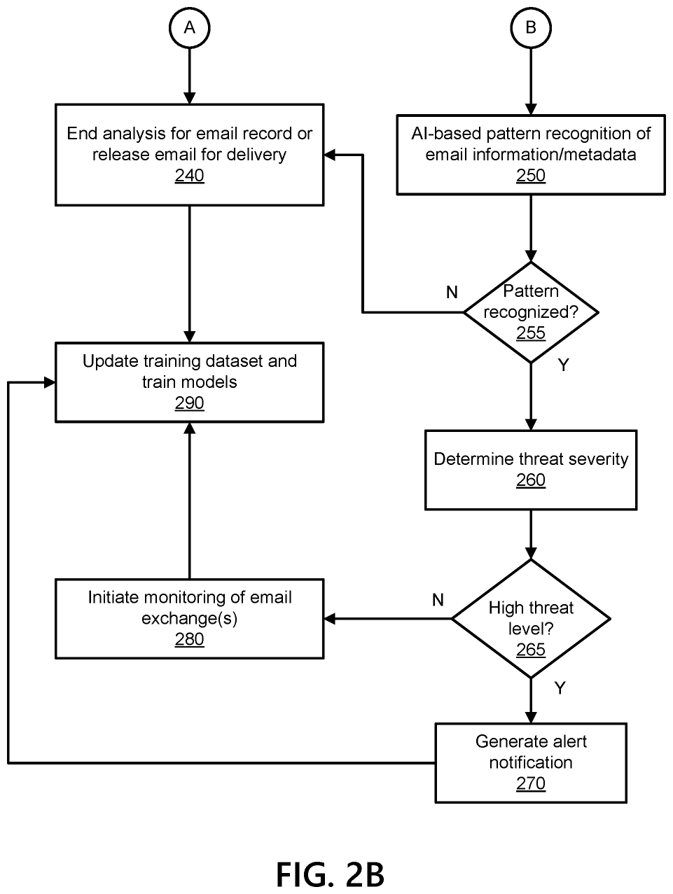

FIGS. 2A and 2B shows an illustrative method for domain age-based monitoring of email communications according to aspects of this disclosure. At 210, the email security platform 110 may receive one or more emails for analysis. In some cases, the email security platform 110 may analyze a data log including information, such as header information, from a plurality of emails received over a period of time. In some cases, the plurality of emails may correspond to a specified business unit or functionality (e.g., investment research computing system, monetary transaction computing system, and the like). For example, subject line information, recipient information, body text information may be analyzed to determine a corresponding target computing system. In some cases, emails may be analyzed in real-time or near real time, or on a periodic basis (e.g., 30 seconds, 1 minute, 10 minutes, or the like). The email security platform may extract header information and/or body information that contains domain information of interest. For example, the domain information may correspond to an email address of a sender of the email, a recipient of the email, or a recipient of a copy of the email. In some cases, the domain information may correspond to a link to a website domain included in the subject or body of the email. In some cases, the domain information may include a domain associated with the sender of the email, while a “reply-to” email address may have a different associated domain. Once gathered, the domain information may be analyzed, such as by querying one or more domain registry computing systems 180 to identify an age of the domain. For example, the email security computing platform 110 may directly query a domain registry computing system 180, or via another computing system, to determine a date of registration for the domain, an elapsed duration from the date of registration (e.g., 1 day, 10 days, 100 days, or the like) or similar registration information. In some cases, if the domain has already been identified, the domain age information may be retrieved from local memory. If the domain age has been retrieved locally, the email security computing platform 110 may compare the saved domain age with a retrieved domain aged to determine accuracy of the stored information. In some cases, a domain may be used previously and re-registered, to a same or different entity. In some cases, other domain registry information may also be retrieved and used for analysis and/or reporting purposes.

Once received, the email security computing platform may process the domain age information, such as by a domain analysis module. The domain analysis module that may include an AI/ML analysis engine, such as the trigger condition module 112a. The AI/ML analysis engine and/or trigger condition module 112a may process one or more trained AI/ML models to trigger additional analysis of an email associated with a domain meeting one or more triggering conditions. At 223, the trigger condition module 112a may first determine whether the email was sent from an external source computing system, such as the email origination computing system 150. If so, the age of each associated domain may be analyzed at 233 to determine whether an age is less than a first threshold condition (e.g., 1 day, 2 days, and the like). If, at 233, the email is a response to an external email the trigger condition module 112a may determine whether the age of an associated domain is less than a second threshold (e.g., 3 days, 5 days, 10 days, and the like) at 235. If, at 277, the email is a new email originating from an internal source and not in reply to an external email, the trigger condition module 112a may determine whether an age of an associated domain is less than a third threshold (e.g., 10 days, 20, days, 30 days, or the like) at 237. If the trigger condition module 112a determines that at least one domain associated with an email meets a threshold condition, an AI/ML-based pattern recognition analysis may be performed on the triggering email at 250, such as by the pattern recognition module 112b. If, the triggering condition is not met at 233, 235, or 237, then domain age-based analysis for the particular email record may end and/or an email may be released for delivery at 240.

In some cases, the trigger conditions may include additional information associated with the domain, the email and/or the age of the domain registration. For example, the trigger condition module 112a, may further analyze additional information retrievable from the domain registry computing system 180, such as ownership information of the domain, whether the domain changed ownership, whether a same domain has been newly registered, whether a same or similar domain has been registered two or more times, additional domains associated with a common owner, and the like. In some cases, the additional information may be used to train the AI/ML model, such as to modify one or more trigger conditions and/or thresholds.

At 250, of FIG. 2B, the pattern recognition module 112b may analyze additional information isolated from and/or associated with an email of interest (or emails of an email message chain) to identify a pattern corresponding to suspected criminal, malicious, or security threatening activities. For example, the pattern recognition module 112b may identify one or more characteristics associated with a pattern associated with malicious activity, such as common key words, email domain naming conventions, activity requests, common salutations, common personal names, and the like. If, at 255, no pattern was recognized and/or if the possibility that the email is associated with malicious activity fails to meet a threshold condition, analysis may end at 240.

If, at 255, the possibility that the email is associated with malicious activity is greater than a threshold, a threat severity may be determined at 260. Here, the pattern recognition module 112b, or a threat analysis module, may analyze additional information to quantify the identified threat, such as by associated a threat level indicator (e.g., a traffic light color indicator, a ranking between 1-10, a ranking between 0 and 100%, and/or the like). For example, if a majority of defining characteristics of a pattern are present (e.g., a domain name, a domain age, keywords, an activity request, and the like), the pattern recognition module 112b may assign a higher threat level indicator value. If fewer defining characteristics of the pattern fail to be present, then the pattern recognition module 112b may assign a lower threat level indicator value. In some cases, the threat level indicator may also be associated with a possibility that the identified threat is related to a threat that may cause personal harm, or high financial harm, the threat level indicator may correspond to a need to escalate the response to outside security and/or law enforcement personnel. If, at 265, the threat level indicator meets an alert level threshold (e.g., 90%), such as for a threat of personal harm, the alerting module 112c may generate an alert that causes an outside computing system (e.g., the enforcement computing system 170) to display a user interface with details of the alert and/or information associated with the analyzed email or emails. In some cases, if the threshold is less than the threshold, but greater than a second threshold, an internal alert may be generated at an internal computing system (e.g., the information security computing system 160), such that the action is assigned to a correct group for action and remediation. If, at 265, the threat level indicator is less than the second threshold, the alert generator 112c may initiate monitoring of emails associated with one or more of the triggering domains and/or monitoring of emails exchanged between the triggering domains and/or the participants of related email communications.

Once an alert is generated at 270 or monitoring of email communications is initiated at 280, pattern information may be stored in the pattern database 112d and/or associated information may be added to the AI model database as an update to the training data set at 290. Before addition of the data to the training data set, personal identifying information may be removed and the data may be anonymized. Once updated, the AI/ML models for domain age-based trigger condition recognition and/or for malicious activity pattern recognition may be trained. In some cases, model training may be performed continually. In some cases, AI/ML model training may be performed periodically (e.g., daily, weekly, monthly, and the like).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
non-transitory memory storing computer-readable instructions that, when executed by the at least one processor, cause the computing platform to:
receive, via a network and the communication interface, an electronic message comprising source domain information and destination domain information;
determine, based on the source domain information, an age of a domain associated with a message sender;
identify, when triggered by the age of the domain associated with the message sender, whether at least a portion of the electronic message comprises an indication of a pattern of malicious activity.
initiate, at a computing device, generation of a user interface comprising at least the portion of the electronic message that comprises the indication of the pattern of malicious activity.

2. The computing platform of claim 1, wherein the instructions cause the computing platform to receive the electronic message in real-time.

3. The computing platform of claim 1, wherein the instructions cause the computing platform to receive a portion of the electronic message from a message log.

4. The computing platform of claim 1, wherein the instructions further cause the computing platform to analyze, by an artificial intelligence/machine learning (AI/ML) model, electronic message information for a triggering pattern associated with the age of a domain associated with the electronic message.

5. The computing platform of claim 4, wherein the triggering pattern comprises a relationship between the domain of the sender and the domain of at least one recipient.

6. The computing platform of claim 5, wherein the relationship between the domain of the sender and the domain of at least one recipient comprises an historical association between the domains identified from at least one historical electronic message.

7. The computing platform of claim 1, wherein the triggering condition comprises the age of the domain associated with the message sender being less that a first threshold.

8. The computing platform of claim 1, wherein the instructions further cause the computing platform to trigger analysis of the electronic message by a second artificial intelligence/machine learning (AI/ML) engine when an age of the domain associated with the message sender is less than a second threshold.

9. The computing platform of claim 1, wherein the instructions further cause the computing platform to trigger analysis of the electronic message by a second artificial intelligence/machine learning (AI/ML) engine when an age of the domain associated with at least one message recipient is less than a third threshold.

10. A method comprising:
receiving, via a network and by a computing device, an electronic message comprising source domain information and destination domain information;
determining, based on the source domain information, an age of a domain associated with a message sender;
identifying, when triggered by the age of the domain associated with the message sender, whether at least a portion of the electronic message comprises an indication of a pattern of malicious activity.
initiating, at a second computing device and via a network, generation of a user interface comprising at least the portion of the electronic message that comprises the indication of the pattern of malicious activity.

11. The method of claim 10, further comprising receiving the electronic message in real-time.

12. The method of claim 10, further comprising receiving a portion of the electronic message from a message log.

13. The method of claim 10, further comprising analyzing, by an artificial intelligence/machine learning (Al/ML) model, electronic message information for a triggering pattern associated with the age of a domain associated with the electronic message.

14. The method of claim 13, wherein the triggering pattern comprises a relationship between the domain of the sender and the domain of at least one recipient.

15. The method of claim 14, wherein the relationship between the domain of the sender and the domain of at least one recipient comprises an historical association between the domains identified from at least one historical electronic message.

16. The method of claim 10, wherein the triggering condition comprises the age of the domain associated with the message sender being less that a first threshold.

17. The method of claim 16, further comprising triggering analysis of the electronic message by a second artificial intelligence/machine learning (AI/ML) engine when an age of the domain associated with the message sender is less than a second threshold.

18. The method of claim 16, further comprising triggering analysis of the electronic message by a second artificial intelligence/machine learning (AI/ML) engine when an age of the domain associated with at least one message recipient is less than a third threshold, wherein the third threshold is greater than the first threshold.

19. Non-transitory computer readable media storing instructions that, when executed by a processor, cause a computing device to:
receive, via a network, an electronic message comprising source domain information and destination domain information;
determine, based on the source domain information, an age of a domain associated with a message sender;
identify, when triggered by the age of the domain associated with the message sender, whether at least a portion of the electronic message comprises an indication of a pattern of malicious activity.
initiate, at a computing device, generation of a user interface comprising at least the portion of the electronic message that comprises the indication of the pattern of malicious activity.

20. The non-transitory computer readable media of claim 19, wherein the instructions further cause the computing device to analyze, by an artificial intelligence/machine learning (AI/ML) model, electronic message information for a triggering pattern associated with the age of a domain associated with the electronic message, wherein the triggering pattern comprises a relationship between the domain of the sender and the domain of at least one recipient.
